(19) United States
(12) Patent Application Publication
(10) Pub. No.: US 2002/0195783 A1
(43) Pub. Date: Dec. 26, 2002

(54) Wheelbarrow

(76) Inventor: Graham Robinson, Stoke-On-Trent (GB)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/164,246

(22) Filed: Jun. 5, 2002

Related U.S. Application Data
(63) Continuation-in-part of application No. 10/079,758, filed on Feb. 19, 2002.

(30) Foreign Application Priority Data
Jun. 21, 2001 (GB) 0115127.3
Sep. 14, 2001 (GB) 0122193.6

(51) Int. Cl. B62B 1/18

(52) U.S. Cl. 280/47.31

(57) ABSTRACT

A wheelbarrow including a main frame having a wheel mounted adjacent a forward end, a handle located at a rearward end and a ground engaging support portion located between the ends. A load carrying body is releasably mounted on the main frame, either directly or by means of a sub frame. Optionally, the body is mounted to tip forward on the main frame to facilitate dumping a load. A second load support is mounted on the ground engaging support to extend laterally across the frame, above the ground, but below the mount for the load carrying body. When the body is removed from the main frame, a load can be carried on the second load support. The second load support is particularly useful for carrying heavy flat loads, such as paving stones.

### CROSS-REFERENCE TO RELATED APPLICATIONS

This application is a continuation-in-part of my copending U.S. application Ser. No. 10/079,758 filed Feb. 19, 2002. Priority is claimed to United Kingdom patent application Serial No. 0115127.3 filed Jun. 21, 2001, and to United Kingdom patent application Serial No. 0122193.6 filed Sep. 14, 2001.

### STATEMENT REGARDING FEDERALLY SPONSORED RESEARCH OR DEVELOPMENT

Not Applicable.

1. Technical Field

The invention relates to wheelbarrows of the kind used by gardeners and builders, and in particular to ones which can be adapted for the carrying of different types of load.

2. Background of the Invention

A traditional wheelbarrow comprises a frame with a single wheel at the front, a body permanently secured thereon for receipt of a load, and two handles extending rearwardly. Such wheelbarrows have been around for many years and are generally successful. However, they do suffer from the disadvantage that it can be difficult to carry certain types of load such as paving slabs. Paving slabs and other generally planar items do not load well into traditional wheelbarrow bodies, due to the shape of the body and the size and shape of the paving slabs. This can mean that, when using a traditional wheelbarrow, the load is very unevenly balanced and hence unstable often causing a tendency for the wheelbarrow to tip over during use.

### BRIEF SUMMARY OF THE INVENTION

According to the present invention there is provided a wheelbarrow comprising: a main frame providing a pair of laterally spaced apart ground engaging support portions and a pair of laterally spaced apart rearwardly extending handles; a wheel rotatably mounted via an axle on the main frame towards the front thereof; a body for receipt of a load removably mounted on the main frame, and a support member extending transversely across the wheelbarrow and located rearwardly of the wheel such that when the body is removed from the main frame an article can be carried on the support member. The wheelbarrow is characterized in that the support member is secured to the main frame on either side above the bottom of the ground engaging support portions. The support member preferably comprises a generally ‘U’ shaped channel.

Preferably, the wheelbarrow further includes a sub frame to which the body is secured and which is pivotally mounted on the main frame.

Preferably, the tip of the body with respect to the main frame is limited by the body and/or the sub frame contacting the wheel.

Preferably, the main frame has a cross member rearwardly of the ground engaging support portions to support the rear of the body and/or sub frame when not in the tipped position.

The wheelbarrow may further include means for selectively preventing pivotal movement of the body with respect to the main frame. The means for selectively preventing pivotal movement of the body may be automatically engageable. The means for selectively preventing pivotal movement of the body may be disengageable when a predetermined load is applied to the body.

Accordingly, it is an object of the invention to provide an alternative form of wheelbarrow which mitigates at least some of the disadvantages of those in the prior art.

Other objects and advantages of the invention will become apparent from the following detailed description of the invention and the accompanying drawings.

### BRIEF DESCRIPTION OF THE DRAWINGS

FIG. 1 is a side elevational view of a wheelbarrow according to the invention;

FIG. 2 is a fragmentary exploded view showing details of the components used to secure the sub frame of the wheelbarrow to the main frame, for the embodiment of FIG. 1;

FIG. 3 is a bottom view of the wheelbarrow of FIGS. 1 and 2; and

FIG. 4 is a side elevational view of the wheelbarrow of FIG. 1 with the body removed and with a load of paving slabs on board.

### DETAILED DESCRIPTION OF THE INVENTION

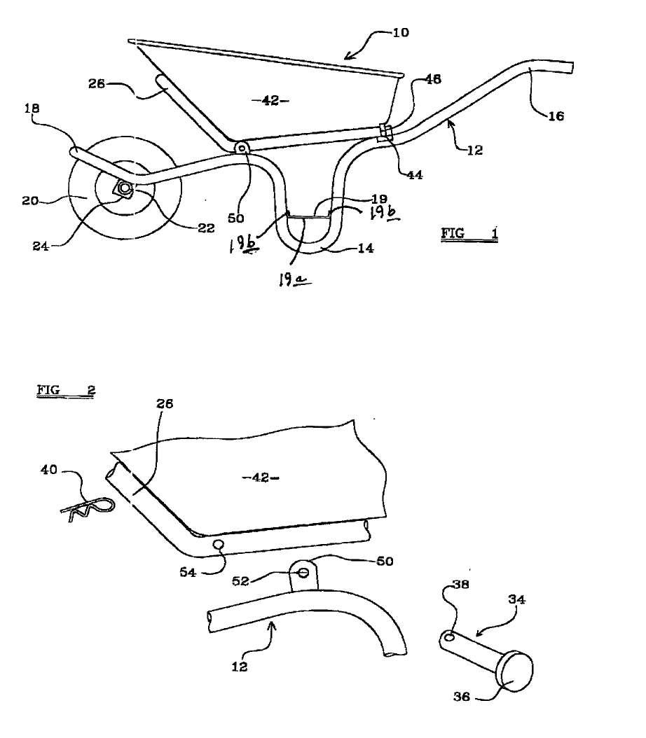

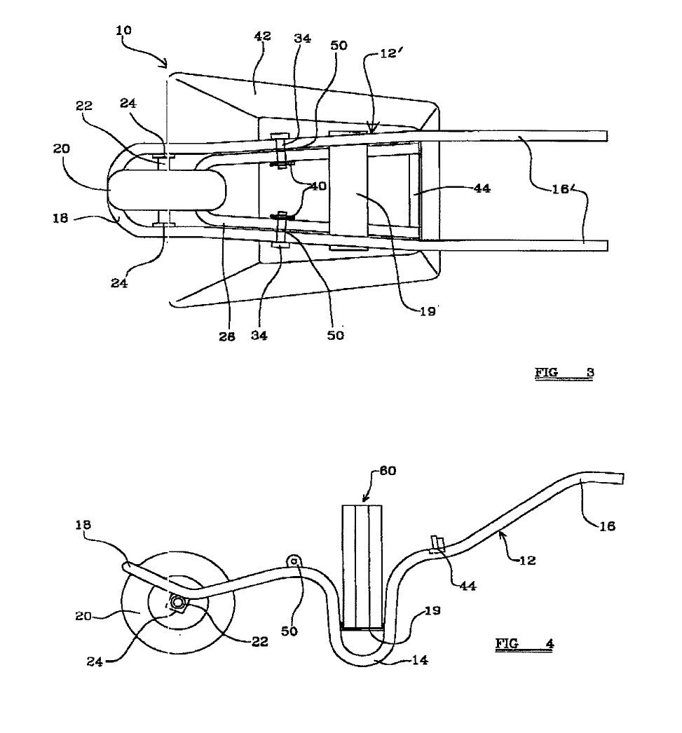

Referring to FIGS. 1 to 4, a wheelbarrow 10 according to the invention comprises a main frame 12, which provides a pair of laterally spaced apart ground engaging support portions 14, a pair of laterally spaced apart rearwardly extending handles 16, and a U-shaped portion 18 at the front thereof. The pair of ground engaging support portions 14 of the main frame 12 take the form of downwardly extending generally U-shaped portions of the main frame 12. Secured to the main frame 12 and located within the pair of the downwardly extending generally U-shaped portions 14 adjacent the bottom thereof is a support member 19. The support member 19 comprises a generally “U” section channel, having a base portion 19a and upstanding sides 19b, which extends transversely across the wheelbarrow 10 between the two ground engaging portions 14. Conveniently both the main frame 12 and the support member 19 are formed of metal and the latter is welded to the former.

A single wheel 20 is pivotally mounted, by means of an axle 22, on the main frame 12 towards the front thereof. The axle 22 is supported below the main frame 12 by means of a pair of brackets 24 such that the wheel 20 only extends upwardly through the U-shaped front portion 18 by a relatively small amount.

The wheelbarrow 10 preferably includes a sub frame 26 which is pivotally and removably secured to the main frame 12 rearwardly of the axle 22 and forwardly of the ground engaging support portions 14 of the main frame 12 as will be described later.

The wheelbarrow 10 also includes a load carrying part or body 42 secured to the sub frame 26, by any appropriate means such as welding, and a cross member 44 secured between the two sides of the main frame 12 just rearwardly of the ground engaging support portions 14, and forwardly of the handles 16. The cross member 44 supports the rear of the sub frame 26, and hence the body 42, when the wheelbarrow 10 is resting on the ground, as shown in FIG. 1, or is being pushed around in normal use.

A bracket 50, bearing holes 52, is secured to each side of the main frame 12 forwardly of the ground engaging support portions 14 and extending upwardly therefrom, on the inner side of the main frame 12. Holes 54 are provided on each side of the sub frame 26 which are aligned with the holes 52 when the sub frame 26 and body 42 are in appropriate relationship to the main frame 12. Pins 34, each having a head 36 at one end and a hole 38 at an opposite end, are used for securing the sub frame 26 to the main frame 12. The pins 34 are inserted through the aligned holes 52 and 54 and secured there by means of spring clips 40 inserted into the pin holes 38. This arrangement provides the advantage over possible alternatives that, when the wheelbarrow 10 is disassembled, there are no parts extending downwardly from the outside of the body 42 and therefore a number of bodies 42 can be readily stacked.

Releasable clips 46, in the form of for example pipe clips, are provided on the cross member 44 or the sub frame 26, or the body 42, to temporarily and selectively secure the body 42 with respect to the main frame 12, to prevent pivotal movement, during normal use. Releasable clips have the advantage that the sub frame 26 can automatically engage in them when returned to the use position from the tipped position.

The wheelbarrow 10 can be used as a tipping wheelbarrow as described in the applicant's co-pending British and United States applications filed under Nos. GB 0120210.0 and 10/079,758, respectively, and for brevity that aspect of the product will not be described further here. The disclosure of the U.S. patent applications is incorporated herein. This is accomplished by the body 42 and the sub frame 26 pivoting on the main frame 12 about the pins 34. This facilitates dumping a load from the body 42. Pivoting will take place when the handles 16 are lifted until a sufficient pivoting force is created to automatically release the clips 46. Pivoting is limited by either the sub frame 26 or the body 42 contacting the wheel 20.

Preferably, bearing pads will be provided where the sub frame 26 and/or body 42 contact the main frame 12 in order to avoid excessive wear to these components, and loud bangs as the body 42 returns to it's use position from it's tipped position. Such bearing pads may be made from any appropriate material, such as those which are relatively dense, but slightly resilient.

The adaptation of the wheelbarrow 10 for the carrying of planar items such as paving slabs will now be described. The body 42 and the sub frame 26 are removed from the main frame 12 by removal of the split pins 40, withdrawal of the pins 34, and lifting off of the body 42 and sub frame 26. Paving slabs 60 can then be loaded as illustrated in FIG. 4 such that they are supported on the support member 19. This method of transporting paving slabs 60 provides significant advantages over the prior art in that the slabs 60 are retained in a stable fashion on the support member 19, and in that the center of gravity of the combination of the main frame 12 and load of slabs 60 is much lower than would be the case if the slabs 60 were carried in a conventional wheelbarrow body, and hence the stability of the combination is greatly improved. As will be seen in FIG. 4 of the drawings, the support member 19 may be positioned at a level below that of the axle 22 when the wheelbarrow is at rest on the ground to provide a low center of gravity for loads on the support member 19.

The removal of the unit comprising the body 42 and sub frame 26, as can be clearly seen from the description, is very quick and likewise the replacement of that unit on the main frame 12 is also very quick. Hence, the wheelbarrow 10 is highly practical for this procedure as no tools are required and the it can be achieved in seconds.

The use of pins 34 and spring clips 40 to secure the sub frame 26 and body 42 to the main frame 12 provides additional advantages in that the body 42 can be readily removed and replaced for whatever reason. This may be necessary if the original body 42 is damaged, as can often occur particularly on building sites, and is unlike conventional prior art wheelbarrows wherein the body is permanently secured to the frame. In addition the wheelbarrow 10 can be transported with the sub frame 26 and body 42 separate from the main frame 12, and then easily reassembled for use. This may be of assistance when delivering the product for sale, and for end users when transporting the wheelbarrow 10 between sites.

It will be appreciated that modifications may be made to the detailed construction of the wheelbarrow 10 without departing from the scope of the present invention. The releasable clips 46 may also take many different forms, rather than being simple pipe clips they may be of a form which the user has to operate to release or secure the body relative to the main frame. In such cases a release mechanism may be provided on the main frame adjacent to one or both handles. Alternatively the releasable clips 46 may be replaced by the use of further pins 34 and spring clips 40, or indeed different fixings, to produce a wheelbarrow which is adaptable as described but which does not provide the tipping facility, just a removable body.

Although the embodiment described above comprises a single wheel embodiment of a wheelbarrow in accordance with the invention embodiments incorporating twin wheels may be constructed without difficulty. In addition the main frame need not comprise a single elongate member bent to form the frame as in the embodiments described, but could comprise a plurality of components secured together by appropriate means.

Furthermore embodiments of wheelbarrows according to the invention need not include a sub frame, particularly if intended for lighter domestic use. In such embodiments appropriate mounting means may be provided secured to the underside of the body.

In the present specification “comprise” means “includes or consists of” and “comprising” means “including or consisting of”.

It will be appreciated that various modifications and changes may be made to the above described preferred embodiment of without departing from the scope of the following claims.

1. A wheelbarrow comprising:
a main frame providing a pair of laterally spaced apart ground engaging support portions and a pair of laterally spaced apart rearwardly extending handles;
a wheel rotatably mounted via an axle on said main frame towards a front thereof;
a body for receipt of a load removably mounted on said main frame; and
a support member extending transversely across said wheelbarrow and located rearwardly of said wheel such that when the body is removed from said main frame an article can be carried on said support member,
said wheelbarrow being characterized in that said support member is secured to said main frame on either side above a bottom of said ground engaging support portions.

2. A wheelbarrow according to claim 1, and wherein said support member comprises a base portion and upstanding sides.

3. A wheelbarrow according to claim 1, and wherein said wheelbarrow further includes a sub frame on which said body is secured and which is removably mounted on said main frame.

4. A wheelbarrow according to claim 3, and wherein said sub frame is pivotally mounted on said main frame and wherein pivoting of said body with respect to said main frame is limited by said body and/or said sub frame contacting said wheel.

5. A wheelbarrow according to claim 1, and wherein said main frame has a cross member rearwardly of said support adapted to support a rear of said body and said sub frame when mounted on said main frame.

6. A wheelbarrow according to claims 3, and wherein said wheelbarrow further includes means for selectively preventing pivotal movement of said body with respect to said main frame.

7. A wheelbarrow according to claim 6, and wherein said means for selectively preventing pivotal movement of said body is automatically engageable.

8. A wheelbarrow according to claim 6, and wherein said means for selectively preventing pivotal movement of said body is disengageable when a predetermined load is applied to said body.
